(19) United States
(12) Patent Application Publication
(10) Pub. No.: US 2012/0282579 A1
(43) Pub. Date: Nov. 8, 2012

(54) Computer System for Safety Training and Certifying Workers for Work on Structures Having Radio Frequency Antennae

(75) Inventor: Darang Tech, San Diego, CA (US)

(73) Assignee: DTECH Communications, San Diego, CA (US)

(21) Appl. No.: 13/101,886

(22) Filed: May 5, 2011

(51) Int. Cl. G09B 19/00

(52) U.S. Cl. 434/219

(57) ABSTRACT

A computerized system for certifying workers to work on a structure having RF antennae, having: (a) an access module to access the computerized system; (b) a non-site-specific training module that displays on-line information about RF antennae; (c) a site-specific training module that displays on-line information about the at least one RF antenna on the structure; (d) a certification module that conducts on-line testing of workers on the non-site-specific information and certifies workers for work at a job site by having the workers acknowledge that they have seen the site-specific information; and (d) a database module which stores: (i) non-site-specific information, (ii) site-specific information, and (iii) records of which workers have both have passed the on-line non-site-specific testing and seen the site-specific information.

### TECHNICAL FIELD

The present invention relates to systems for safety training workers who work on buildings or other facilities including light poles, power line towers, etc. with Radio Frequency (RF) antenna, such that the workers are made aware of the correct safety procedures for working near the antenna, and such that records can be kept of their training.

### BACKGROUND OF THE INVENTION

Today many large buildings have one or more RF antennae mounted thereon. Unfortunately, it can be dangerous for workers to work on these buildings in the vicinity of these RF antenna for extended periods of time. The danger levels vary depending upon the type of antennae, their locations, and the durations of time that building workers are near the RF antennae. As a result, these buildings are required to have an RF antenna safety plan. These safety plans spell out the locations of the antennae for the workers and tell them how long they can be working near the RF antennae. In addition, to comply with legal regulations, records must be kept as to which workers have reviewed these safety plans and when they reviewed these safety plans.

Therefore, the need exists for a system to train workers about the dangers of working near RF antennae. This system should also spell out the specific RF dangers found at the particular building locations where they will be working. A need also exists to provide detailed recordkeeping as to which workers are approved (i.e.: certified) to work on which particular building sites.

### SUMMARY OF THE INVENTION

The present invention provides an on-line method of safety training and of certifying workers to work on a structure having at least one RF antenna, comprising: (a) displaying non-site-specific information about RF antennae to the workers; (b) conducting on-line testing of the workers on the non-site-specific information, by: (i) presenting questions to the workers; (ii) recording the workers' answers to the questions; and (iii) determining whether the workers have passed the on-line non-site-specific testing; and if the workers have passed the on-line non-site-specific testing, then (c) displaying site-specific information about the at least one RF antenna on the structure to the workers; (d) certifying workers for work at a job site by having the workers acknowledge that they have seen the site-specific information; and then (e) informing a facility manager that the workers have both have passed the on-line non-site-specific testing and have seen the site-specific information.

Preferably, the displaying of non-site-specific information includes displaying general RF safety legal compliance information. In addition, displaying site-specific information preferably comprises the computer system displaying: (i) photographs of the particular RF antennae found on the building structure, and (ii) on-screen 3D computer models of the building structure showing the positions of the RF antennae. In addition, control zones and hot zones can also be displayed superimposed on the 3D computer models of the structure and antennae.

By on-line viewing of these photographs and 3D models, the building workers are quickly taught where the RF antennae are positioned, and what they look like. By seeing the RF control and hot zones as images displayed on top of the 3D models of the building, the workers are then able to easily view these areas, such that they can quickly recognize them when later working on the building.

In preferred aspects, the site-specific information displayed comprises both RF measurements predicted by standard computer modeling software, and RF measurements that are actually taken at the building site. Preferably as well, these two types of measurements can then be merged and displayed together.

The present invention also comprises a computerized system for safety training and certifying workers to work on a structure having at least one RF antenna, comprising: (a) an access module permitting workers to access the computerized system; (b) a non-site-specific training module that displays on-line information about RF antennae to the workers; (c) a site-specific training module that displays on-line information about the at least one RF antenna on the structure to the workers; (d) a certification module that conducts on-line testing of the workers on the non-site-specific information and certifies workers for work at a job site by having the workers acknowledge that they have seen the site-specific information for the job site; and (d) a database module which stores: (1) non-site-specific information called up by the non-site-specific training module during the on-line testing, (ii) site-specific information called up by the site-specific training module during the on-line testing, and (iii) records of which workers have both have passed the on-line non-site-specific testing and have seen the site-specific information.

A first advantage of the present invention is that it provides training that is both general (i.e. non-site-specific) and site-specific. For example, the general information can be background information on identifying different types of RF antennae, and knowing their dangers. The site-specific information can be detailed information about the particular RF antennae found on the particular building or structure that the worker is being certified to work on.

A second advantage of the present invention is that it provides an excellent visual on-screen presentation as to where exactly the RF control zones and hot zones are located on the building (or tower, or any other job site). This can be achieved by simultaneously showing the workers photos of the physical building site, together with on-screen 3D models of the buildings.

A third advantage of the present invention is that it preferably displays actual RF measurements taken at the building site (as opposed to simply using standard software to predict the size and intensity of the RF fields around the antennae). This is particularly advantageous in that it deals with the case of antennae that are mounted close to one another. Normally, it is difficult to successfully predict the actual RF measurements when different RF sources are close to one another. (This is due to the interference between the RF waves that are emitted). However, in accordance with the present invention, a user can see the interaction of these different antennae (and detect worse-case scenarios, where the fields of the antenna overlap to create additional danger areas).

A fourth advantage of the present invention is that it provides a detailed record keeping system recording which workers have been trained (and certified) for working on which particular building sites. Specifically, each worker is required to sign a personal agreement for working on each building worksite (after they have successfully completed their training for work for that particular site). The present system stores and records these personal agreements.

### BRIEF DESCRIPTION OF THE DRAWINGS

FIG. 1 is a schematic representation of the physical components of the system.

FIG. 2 is a flow chart showing aspects of the preferred method.

FIG. 3 is a flow chart showing aspects of the preferred method with respect to a worker interacting with the site-specific training module of FIG. 1.

FIG. 4 is a screenshot of a startup screen.

FIG. 5 is a screenshot of a registration screen for accessing the system.

FIG. 6 is a screenshot showing building sites a worker has been approved to work on.

FIG. 7 is a screenshot of a search screen for looking up building sites.

FIG. 8 is a screenshot of a request form for accessing training to a particular building site.

FIGS. 9 and 10 are screenshots showing the display of non-site-specific information.

FIG. 11 is a screenshot where a worker requests on-line testing of non-site-specific information.

FIG. 12 is a screenshot of a site-specific display of a 3D model of a building, and a photo gallery of the building.

FIG. 13 is similar to FIG. 12, but also shows RF hot zones.

FIG. 14 is similar to FIG. 12, but also shows RF measurement locations.

FIG. 15 is a rotated and zoomed in view similar to FIG. 13.

FIG. 16 is a screenshot of a worker-specific and site-specific Agreement presented to a worker upon the completion of the worker's training in accordance with the present invention.

### DETAILED DESCRIPTION OF THE DRAWINGS

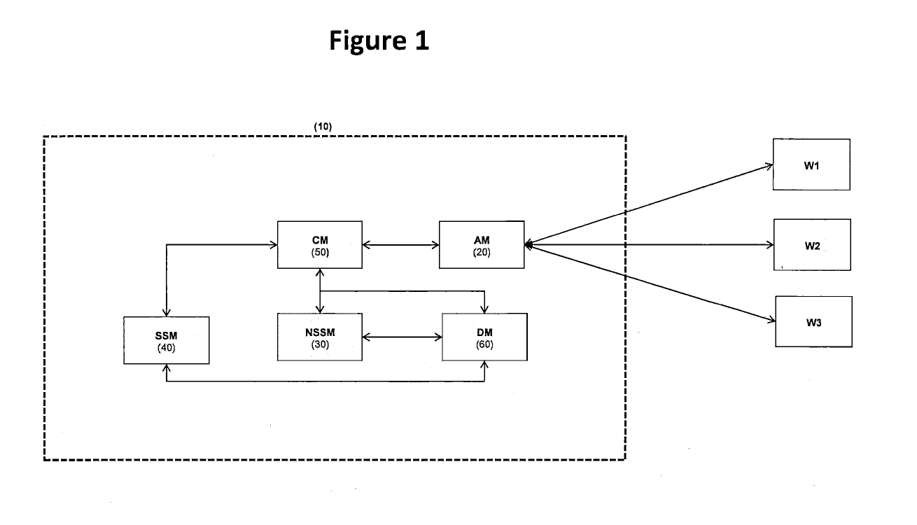

The present invention provides a computerized system which operates an on-line training tool for safety training and certifying workers to work on a structure having at least one RF antenna. FIG. 1 provides an illustration of this system 10, as follows.

System 10 illustrates a dedicated physical computer system running on one or more physical computers that may be embodied in computer readable media that comprise: (a) an access module 20 permitting workers to access the computerized system; (b) a non-site-specific training module 30 that displays on-line general information about RF antennae to the workers; (c) a site-specific training module 40 that displays on-line information about the at least one RF antenna on the structure to the workers; (d) a certifying module 50 that conducts on-line testing of the workers, and certifies particular workers for particular job sites; and (e) a database module 60.

As will be explained, certifying module 50 conducts on-line testing of non-site-specific training, and presents site-specific information to workers. In addition, certifying module 50 determines which workers have passed the on-line testing.

Database module 60 stores information with regard to: (i) non-site-specific information called up by non-site-specific training module 30 during the on-line testing, and (ii) site-specific information called up by site-specific training module 40 during the on-line testing. In addition, database module 50 also stores identifying information as to which workers have passed the on-line testing and what site-specific information they have viewed (and are thus permitted to work on each of the various building structures).

In operation, a plurality of workers W1, W2, . . . etc. access the present on-line system 10 over the internet. Access module 20 receives both a worker's personal identifying information and site-specific identifying information prior to authorizing the worker to access computerized system 10.

In operation, worker W1 may be seeking approval to work on a first building; worker W2 may be seeking approval to work on a second building; and worker W3 may be seeking approval to work on both the first and second buildings. In such a case, worker W1 receives site-specific information about the first building, worker W2 receives site-specific information about the second building, and worker W3 will receive site specific training and testing for each of the first and second building site. (Workers W1, W2 and W3 all receive the same non-site-specific safety training). When workers W1, W2 and W3 pass their non-site-specific tests and have viewed the RF information for their particular job sites, they will each be certified to work on the particular building sites on which they were trained and tested. Database 50 keeps a record of which building worksite(s) each of the various workers W have acknowledged viewing.

The non-site-specific information stored in database module 60 is displayed to the workers W1, W2, . . . etc. by the non-site-specific training module 30. Similarly, the site-specific information stored in database module 60 is displayed to workers W1, W2, . . . etc. by site-specific training module 40. Site-specific training module 40 displays site-specific information for a plurality of different work sites. For example, worker W1 will be viewing site-specific information about the first building site while worker W2 is viewing site-specific information about the second building. Worker W3 will view the site-specific information for each of the first and second buildings, and be tested on them separately. Typically, a facility manager determines which workers W are permitted to access the computerized system 10, and which workers W are then permitted to access which specific site information. As such, access module 20 may be controlled by the facility manager.

Certifying module 50 communicates separately with each of workers W1, W2, W3, and first tests these workers on the same non-site-specific information. After the workers have passed that test, they then receive site specific information for each of the different work sites that they will be working on. As will be shown below, the actual site-specific training which site-specific training module 40 displays for each of the workers preferably includes: (i) photographs of the at least one RF antenna on the building or structure, and (ii) 3D computer models showing the building structure with the RF antenna(e) thereon. Most preferably, the workers will each simultaneously view displays of photographs and 3D computer models of the structure, the locations of the RF antenna(e) and the RF hot zones or control zones around these antenna(e).

Displaying the site-specific information preferably comprises displaying RF control zones and hot zones on the 3D computer models of the structure and the RF antenna(e). In preferred aspects, the control zones (where risk is lower) and hot zones (where risk is higher) may be represented by different colors. Preferably, the control zones and hot zones may be calculated by: (i) determining RF measurements at the building structure with standard computer software, or by (ii) taking RF measurements on the building structure near the at least one RF antenna and merging the RF measurements taken at the structure with the RF measurements determined by the computer software. The merged RF measurements can then be displayed to the workers. The site-specific training module 40 preferably displays RF measurements taken at the structure near the RF antenna(e) merged together with RF measurements determined or predicted by standard computer software.

Certifying module 50 communicates separately with each of workers W1, W2, W3 over the Internet, testing them on general non-site specific RF antenna safety procedures. In this regard, certifying module 50 includes: (i) a system for asking the workers questions; (ii) a system for recording the workers' answers; and (iii) a system for recording the results of these answers in database module 60. Certifying module 50 then certifies workers W1, W2, W3 (after they have passed the on-line testing) by: (a) sending a site-specific Agreement to the workers that have passed the test; (b) requesting the workers execute the site-specific Agreement; (c) receiving the executed site-specific Agreements from the workers; and (d) storing the executed site-specific Agreements in database module 60.

In general terms, the present invention provides an on-line method of safety training and of certifying workers to work on a structure having at least one RF antenna, comprising: (a) displaying non-site-specific information about RF antennae to the workers; (b) conducting on-line testing of the workers on the non-site-specific information, by: (i) presenting questions to the workers; (ii) recording the workers' answers to the questions; and (iii) determining whether the workers have passed the on-line non-site-specific testing; and if the workers have passed the on-line non-site-specific testing, then (c) displaying site-specific information about the at least one RF antenna on the structure to the workers; (d) certifying workers for work at a job site by having the workers acknowledge that they have seen the site-specific information; and then (e) informing a facility manager that the workers have both have passed the on-line non-site- specific testing and have seen the site-specific information.

In addition to storing worker information, database 50 preferably also stores site-specific audit and compliance information for each of the building sites. Preferably, a facility manager has access to access module 20 such that the facility manager can grant (or deny) access to each of workers W1, W2 and W3.

Each of workers W1, W2 and W3 interact separately with access module 20, by: (a) inputting personal identifying information; and (b) inputting site-specific identifying information (such as requesting access to a specific building structure by entering a site code). Access module 20 the verifies the site codes against worker ID to ensure that the worker is to get access to the specific site.

The present invention also includes a software program embodied on a tangible, computer readable media comprising instructions for safety training and for certifying workers to work on a structure having at least one RF antenna, by: (a) displaying non-site-specific information about RF antennae to the workers; (b) conducting on-line testing of the workers on the non-site-specific and information, by: (i) presenting questions to the workers; (ii) recording the workers' answers to the questions; and (iii) determining whether the workers have passed the on-line non-site-specific testing; and if the workers have passed the on-line non-site-specific testing, then (c) displaying site-specific information about the at least one RF antenna on the structure to the workers; (d) certifying workers for work at a job site by having the workers acknowledge that they have seen the site-specific information for the job site; and then (e) informing a facility manager that the workers have both have passed the on-line non-site-specific testing and have seen the site-specific information.

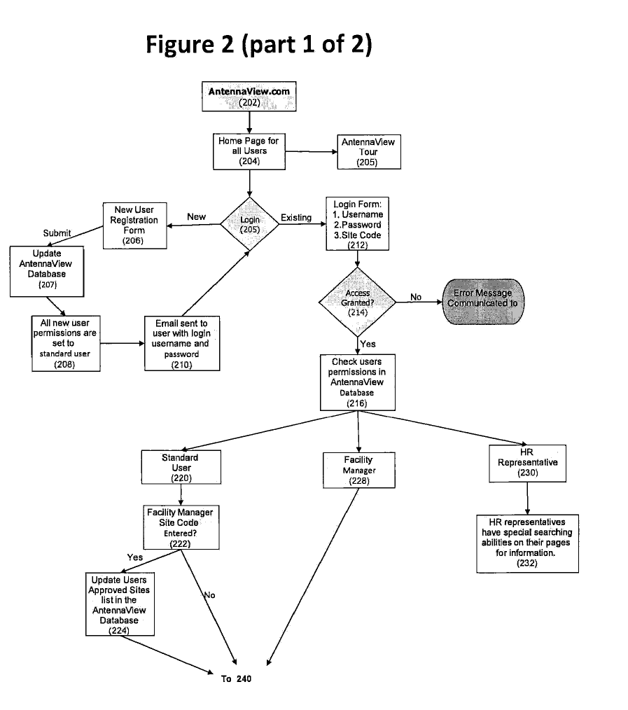

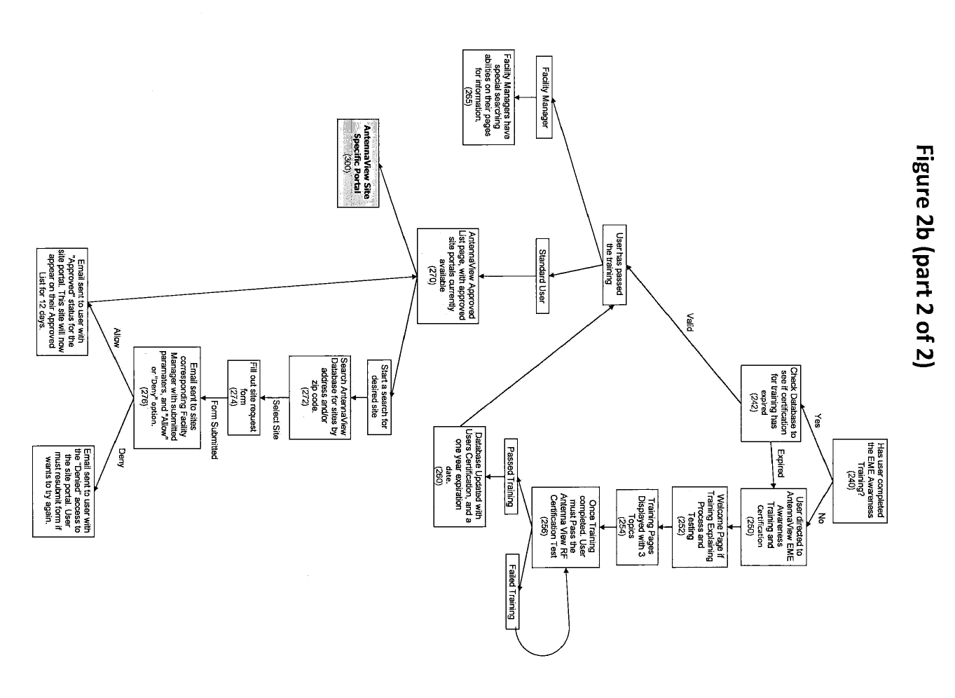

Referring next to FIG. 2, a flow chart of the preferred method 200 is provided. At step 202, a worker W first enters a webpage in their Internet browser. As illustrated, this webpage may be “AntennaView.com”, but it is to be understood that the present system could be hosted on another suitable webpage. Next, at step 204, a homepage is displayed. (An exemplary homepage is shown in the screenshot of FIG. 4.) Next, at step 205, the worker is prompted for a login. If the worker is a new user, the new user is registered at step 206 (as seen in the screenshot of FIG. 5). Next, database 50 will be updated at step 207, such that the new user's permissions can be set to that of a standard user at step 208. Optionally, the permissions set at step 208 may be set by a standard user, an HR representative or by a facility manager. An email will be sent to the user with login information at step 210.

The worker then enters their username and password at step 212. At step 214, the access module (20 in FIG. 1) then determines whether to grant system access to this particular user. If the user is granted access, the system then checks their permissions at step 216. Once the user has been logged in, they may be recognized by the system as a standard user (i.e. worker W1, W2, W3 . . . etc.) at step 220, a facility manager at step 228 or an HR manger at step 230. The HR manager can preferably access the database 50 at step 232 to search for which workers have been certified for working on which particular building site.

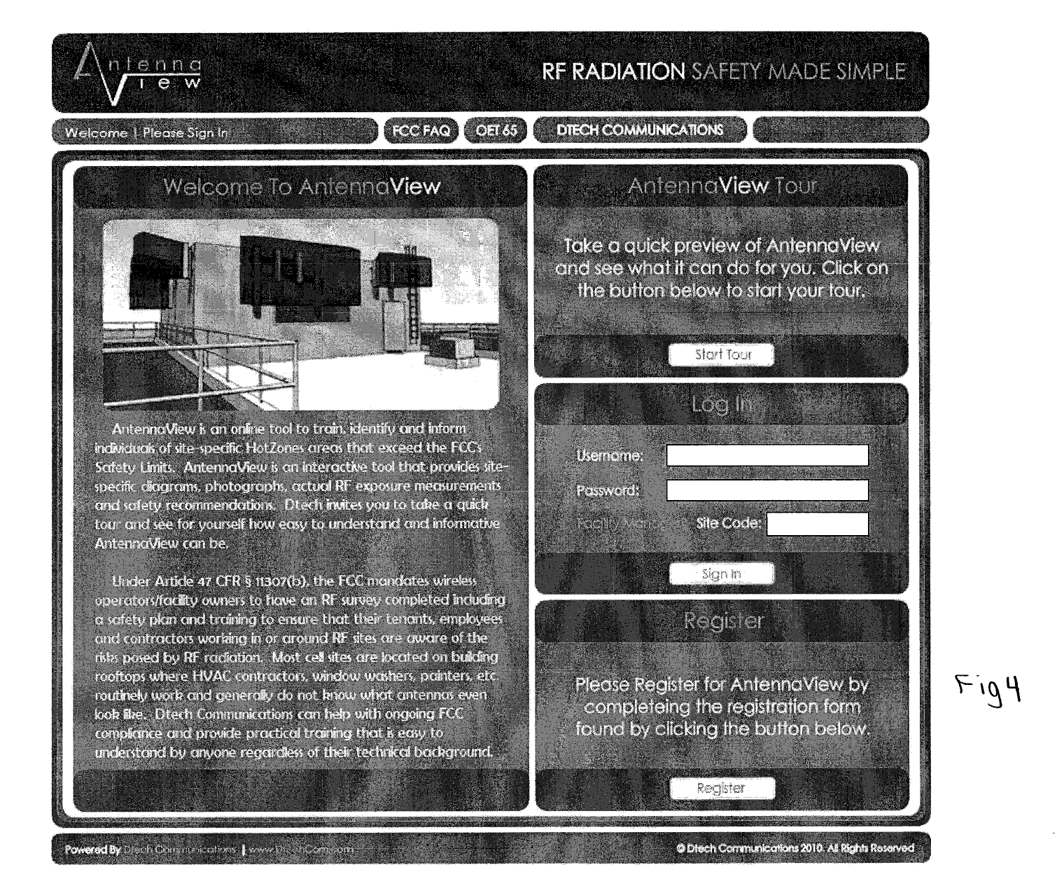

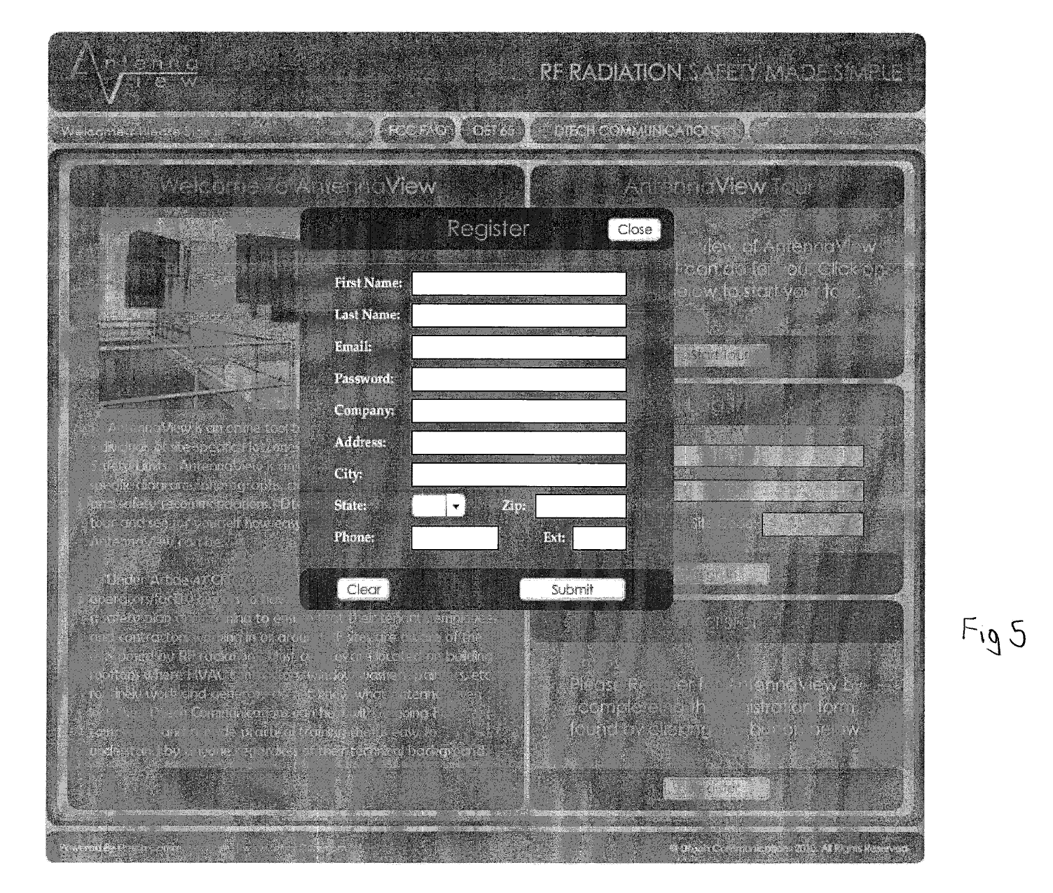

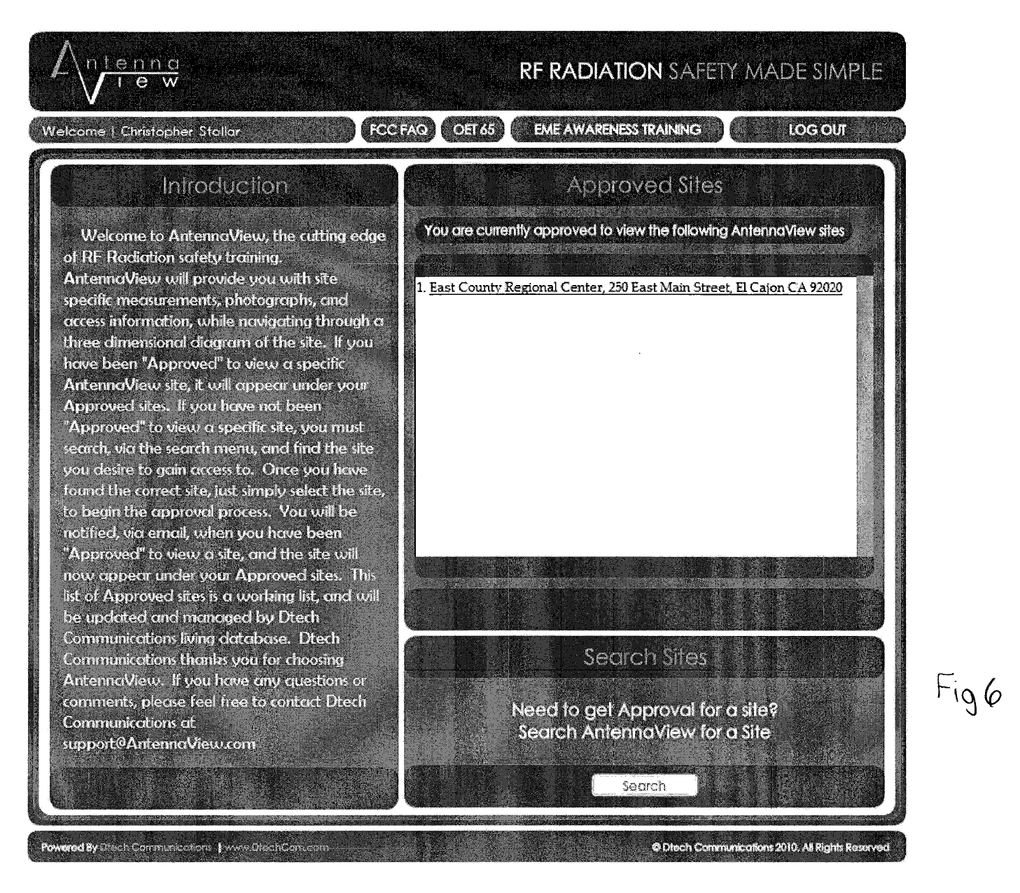

Assuming the person logged in is a standard user (i.e. worker W), the worker then enters a building site code (i.e.: the worker tells the system which building they would like to be certified for work on). A screenshot displaying the building worksites the worker is already certified to work on is shown in FIG. 6, and a screenshot of a search screen where the worker enters the building site address is shown in FIG. 7. Alternatively, should the worker still need the facility manager's permission to obtain certification for work at a particular building site, the worker may make such a request using the screen as shown in FIG. 8. At step 224, the database 50 is updated to record that the worker has been granted access to training on a particular building work site.

Next, at step 240, the system accesses the database 50 to determine whether this particular worker has already completed non-site-specific (i.e.: general) safety training and testing. If the worker has completed the non-site-specific safety training, the system proceeds to step 242 where a determination is made as to whether the training certificate is still valid (In most cases, they will typically be valid for a period of time such as one year).

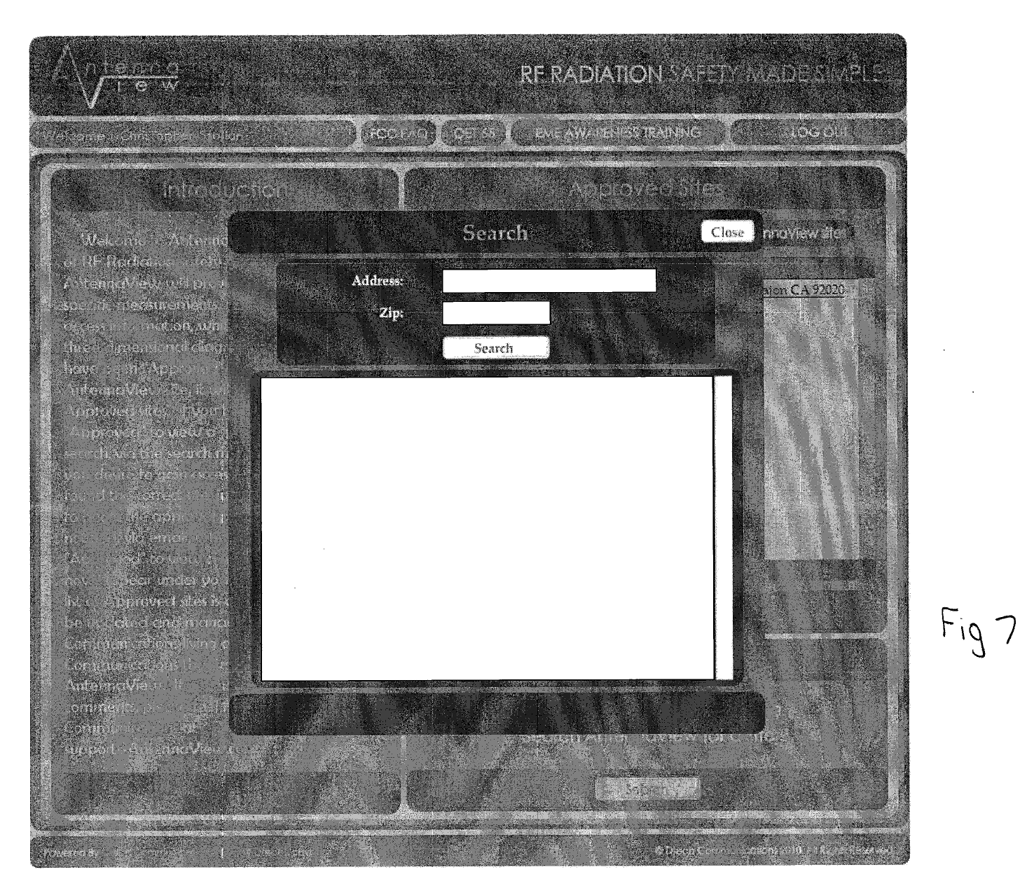

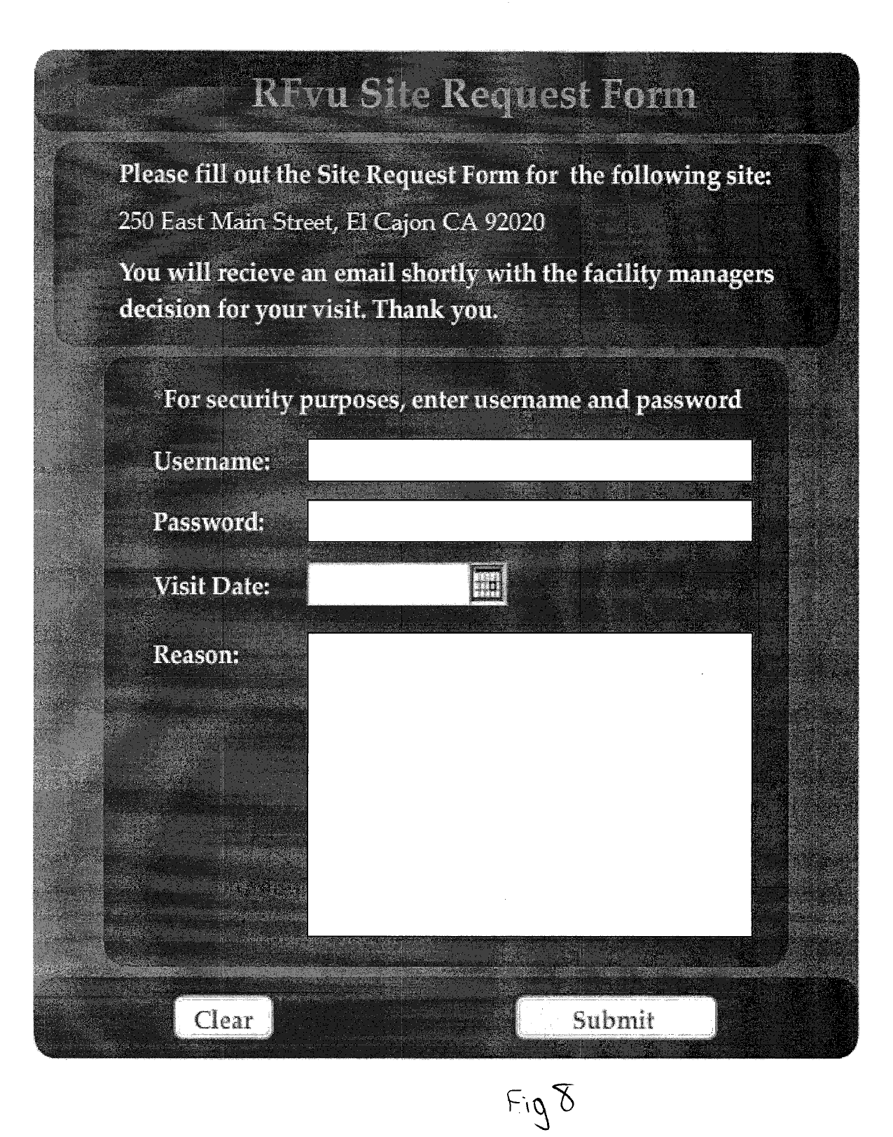

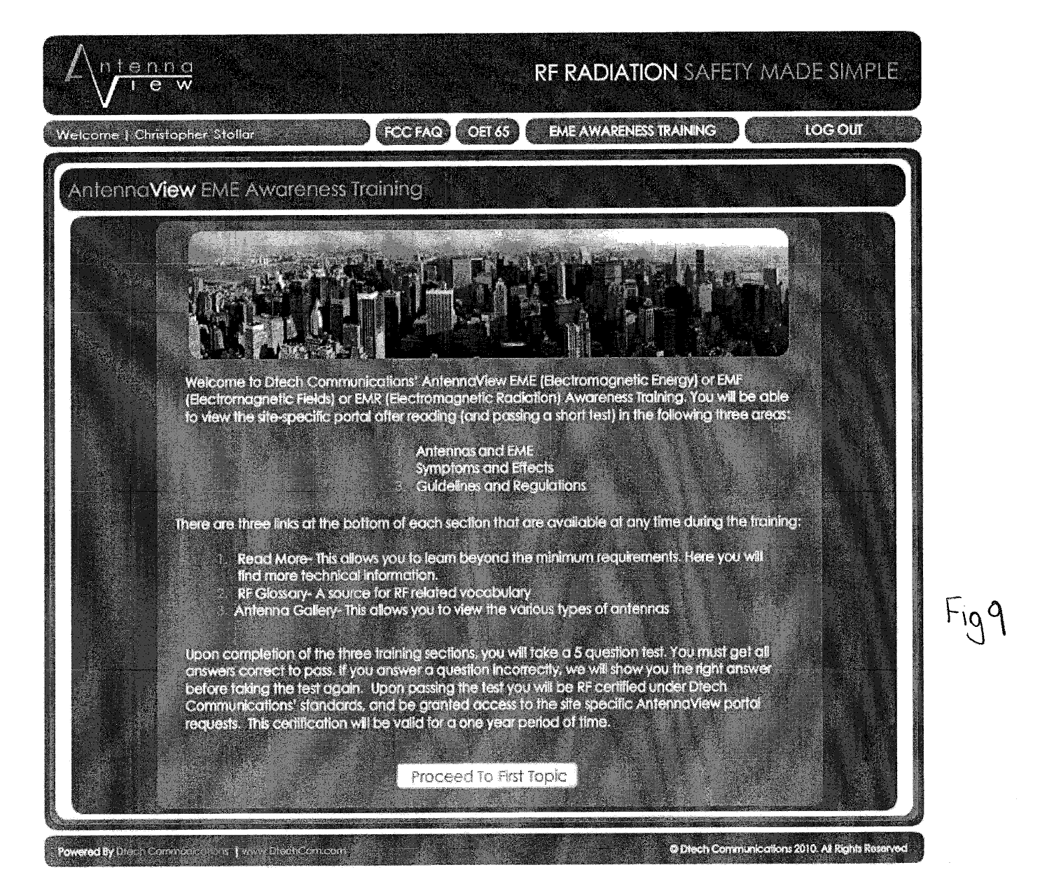

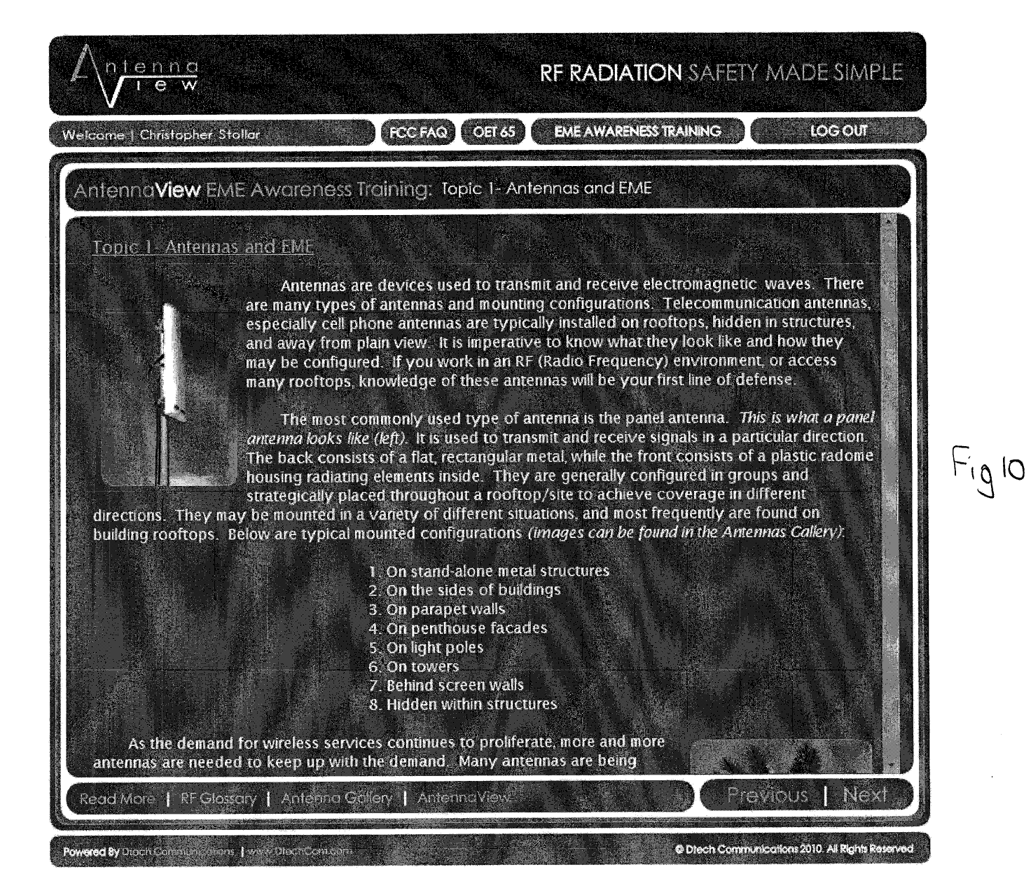

At step 250, the worker is given non-site-specific training. A welcoming page will be presented (step 252), followed by the training pages (step 254), followed by an on-line certification test (step 256). Step 254 may optionally comprise training pages displaying information about non-site-specific issues, including: (a) Antenna and RF radiation, (b) Symptoms and effects of RF radiation, and (c) Guidelines and regulations. Step 256 may optionally comprise a number of multiple choice questions that all must be answered correctly. An example of the welcoming page is shown in FIG. 9, one of the training pages in FIG. 10 and the user's request to start the non-site-specific testing on page 11. When the worker passes the test (at step 260), their records in database 50 will be updated. (A facility manager can access these records at step 265).

Next, at step 270, the second part of the testing begins where the worker searches for a specific building site at 272 by entering the building's address or zip code. (FIG. 7). The worker can then fill out a request form (FIG. 8). The worker can be asked to fill out their intended visit date and the purpose for their visit to the job site. Next, at step 276, an email can be sent to the worker, allowing or denying them access.

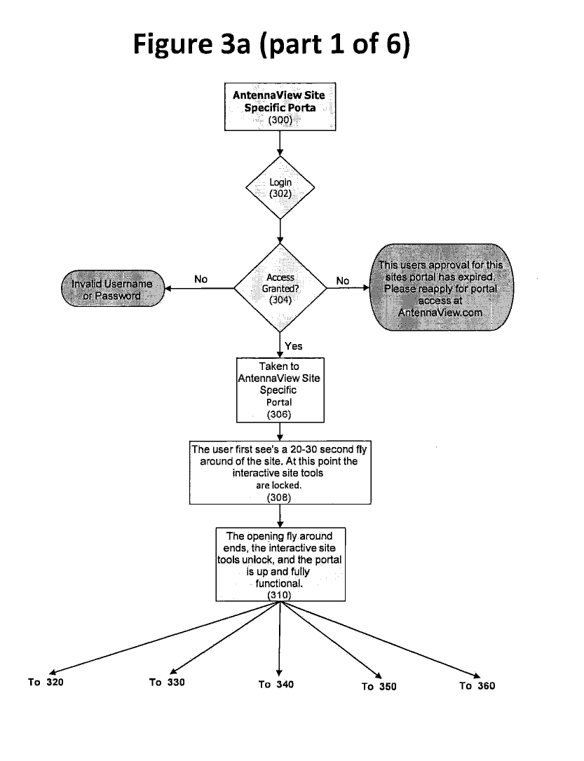

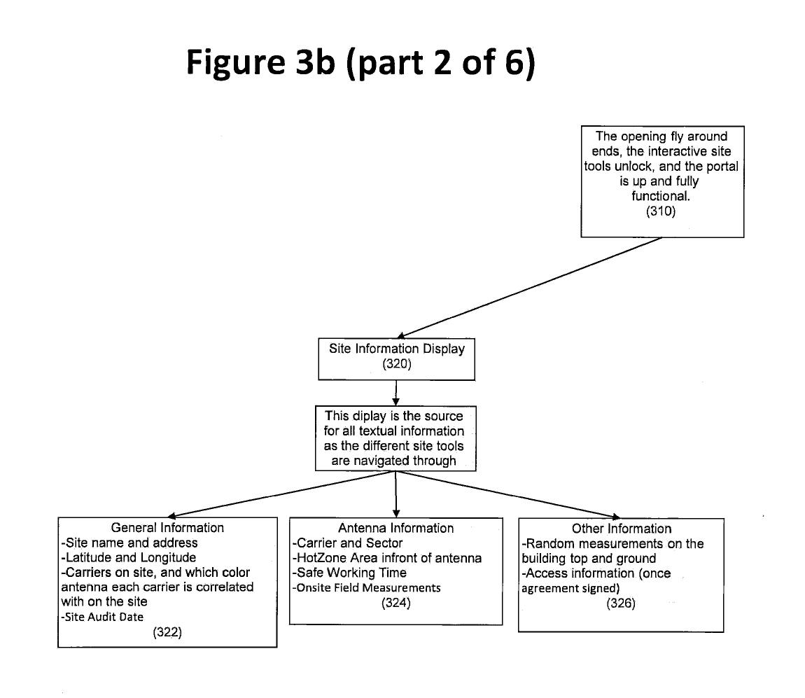

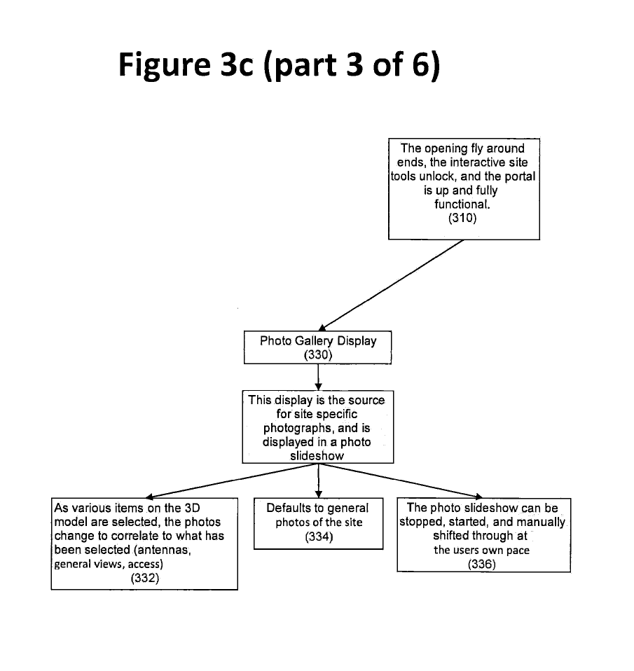

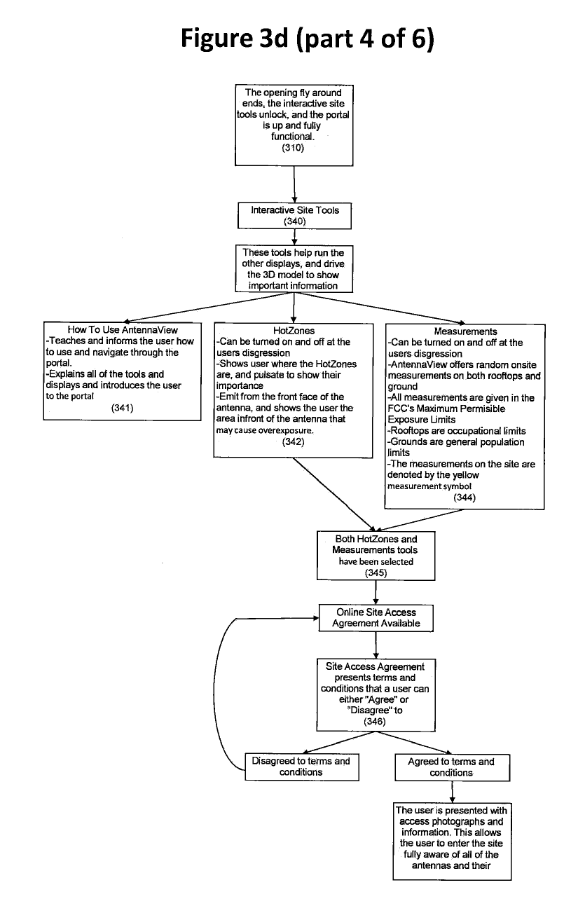

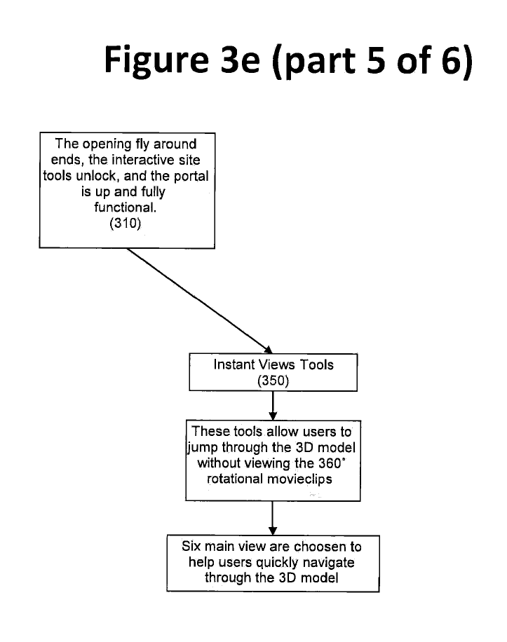

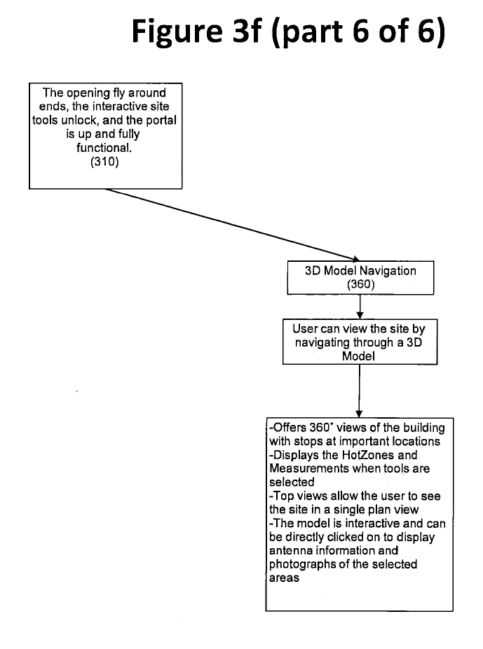

Next, the user advances to the site-specific training at step 300 (where the user/worker is given safety training for work on a particular building site). This continues on FIG. 3, as follows.

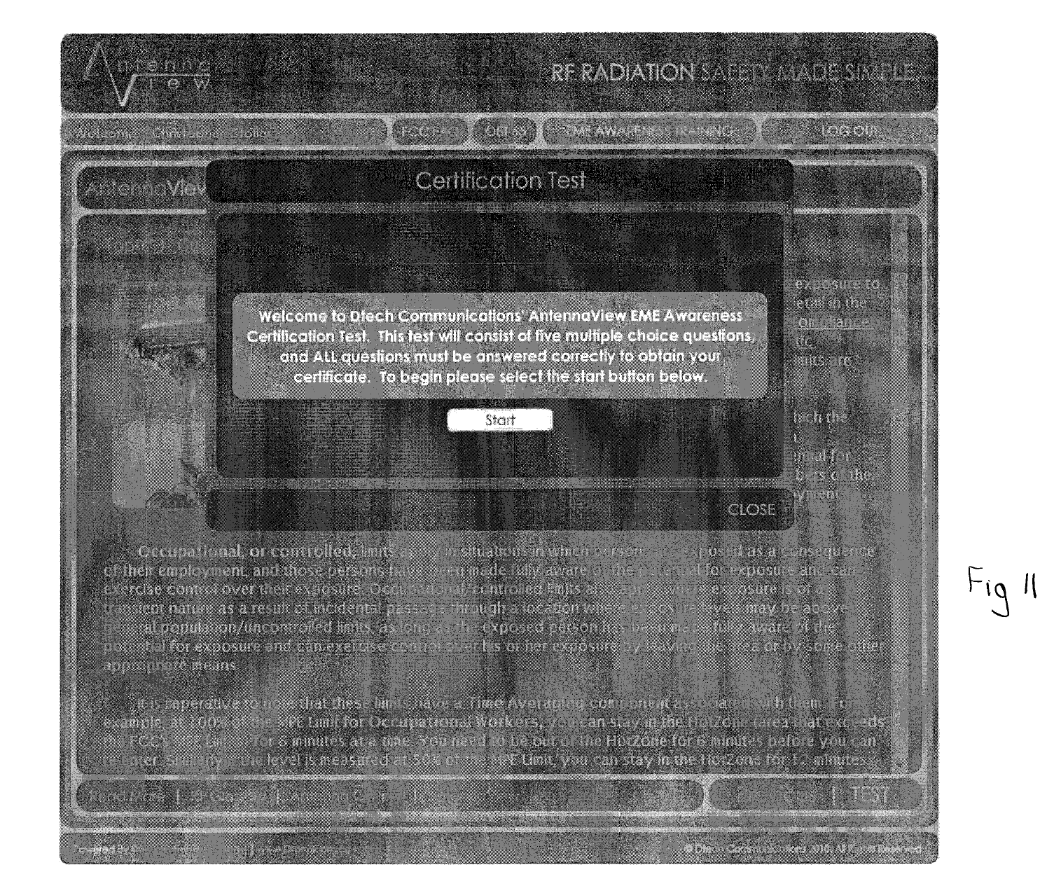

If the user isn't already logged in, they can log in at optional step at 302. Next, access can be granted at 304, and the user taken to the site-specific training at step 306. The user can then be given a quick on-screen fly around of the building site while the webpage is loading. Next, the user is presented with a webpage as shown in FIG. 12. The user is then given several different options on this screen, as follows.

At step 320, the user is given information about the building worksite. This information may optionally include general building information at 322 (including site name, address, location, names of RF carrier companies with RF antennae on site, and building audit date). In addition, the workers may be given antennae information at 324 (including carrier locations, hot zone areas, safe working times, and on-site RF field measurements). (The webpage illustrated in FIG. 12 shows these features). In addition, the workers may be given other information at 326 (including random RF measurements of RF at the top and bottom of the building, and access information).

At step 330, a photo gallery of the building site and antennae may be displayed. This photo gallery may include general default photos 334 or a slideshow 336. The slideshow 336 may be stopped and started at the user's convenience. This feature of the invention is important in that it vividly conveys to the workers exactly what the building and antenna(e) look like, making them very easy to recognize in the field. (The webpage illustrated in FIG. 12 shows the link to this photo gallery).

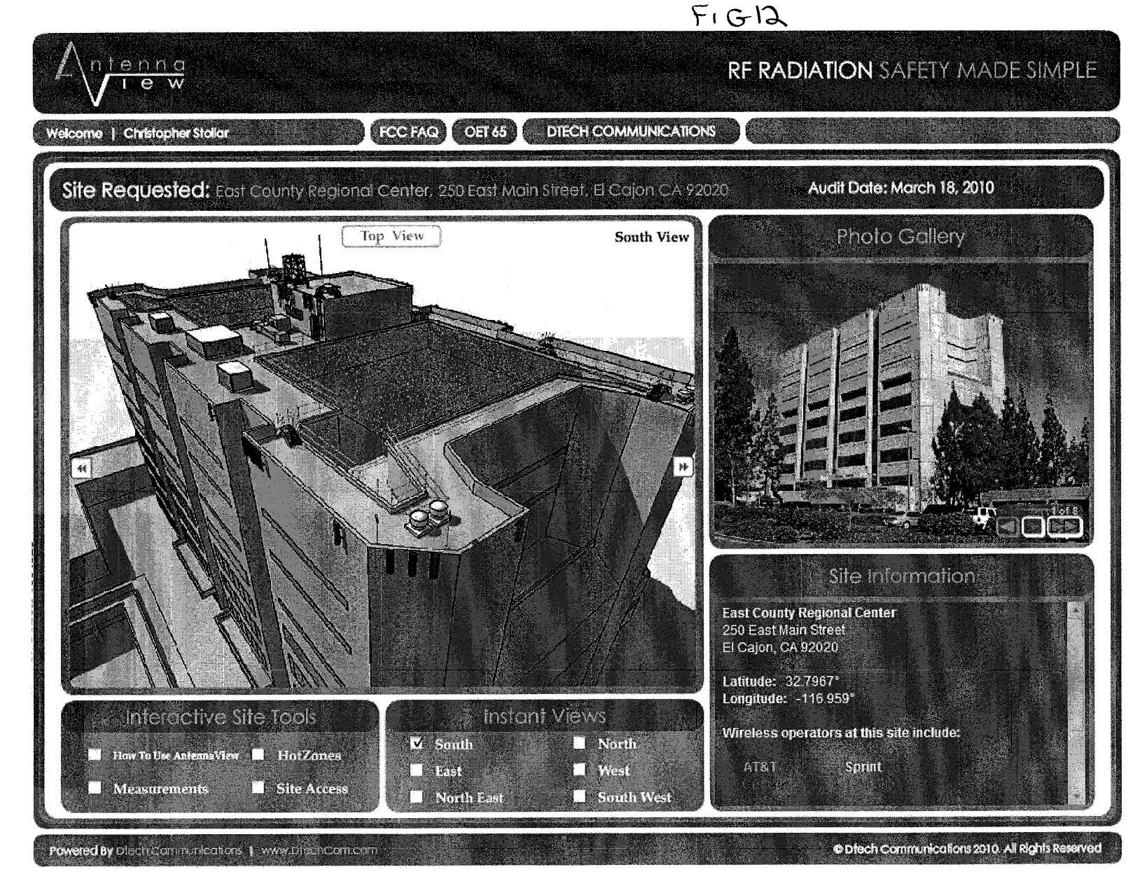

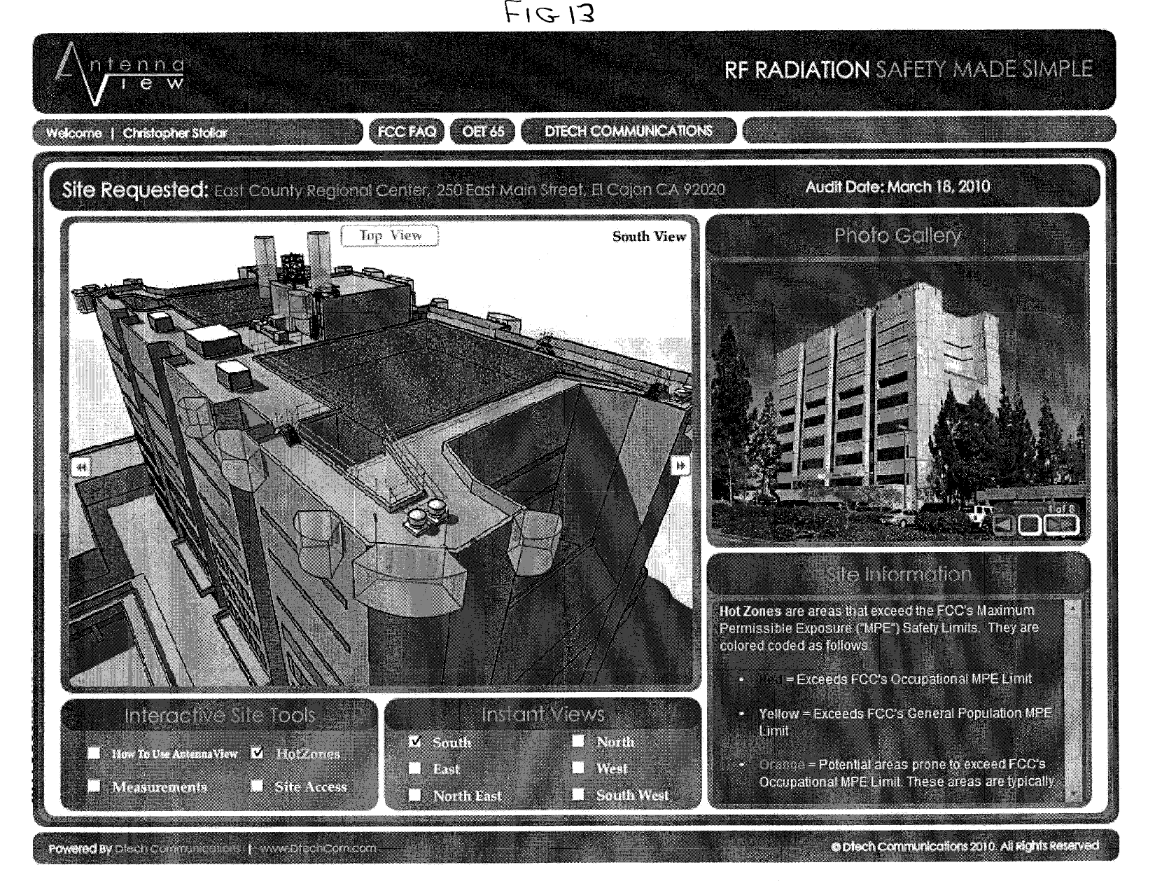

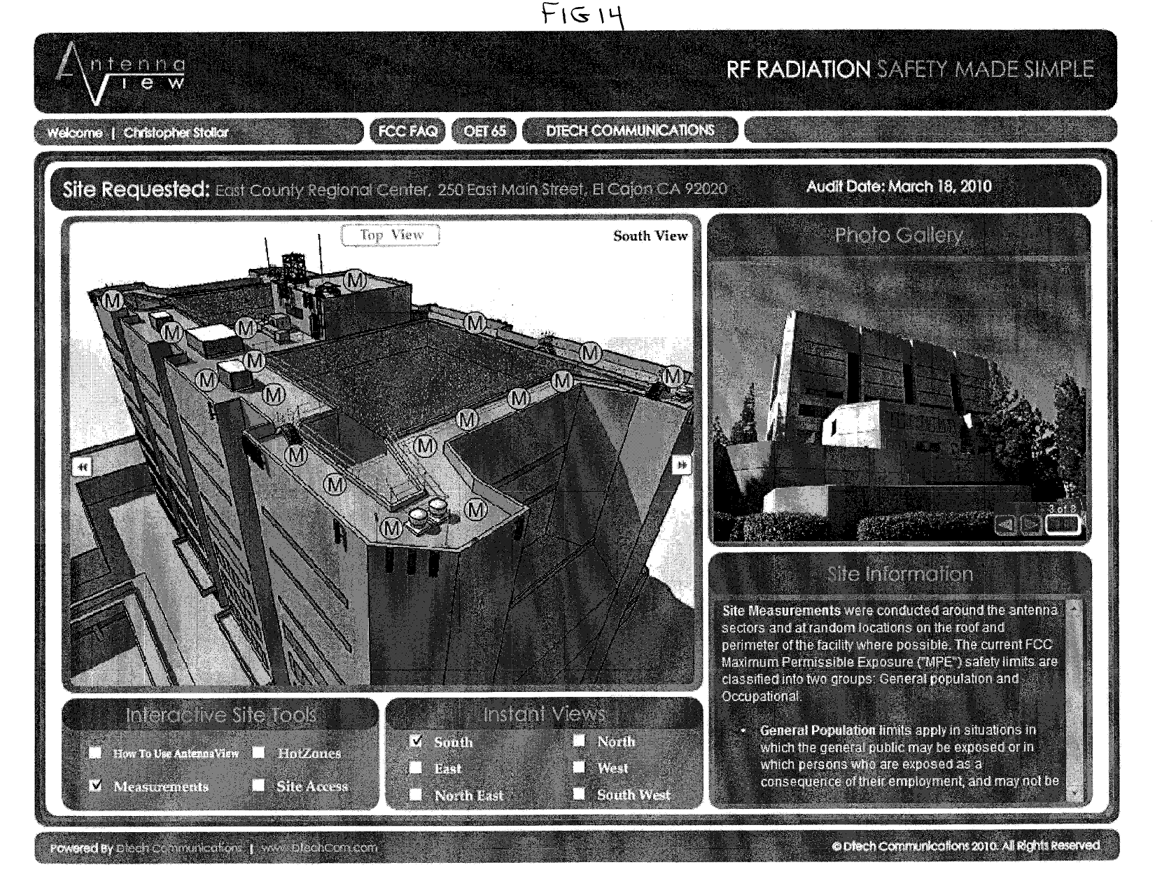

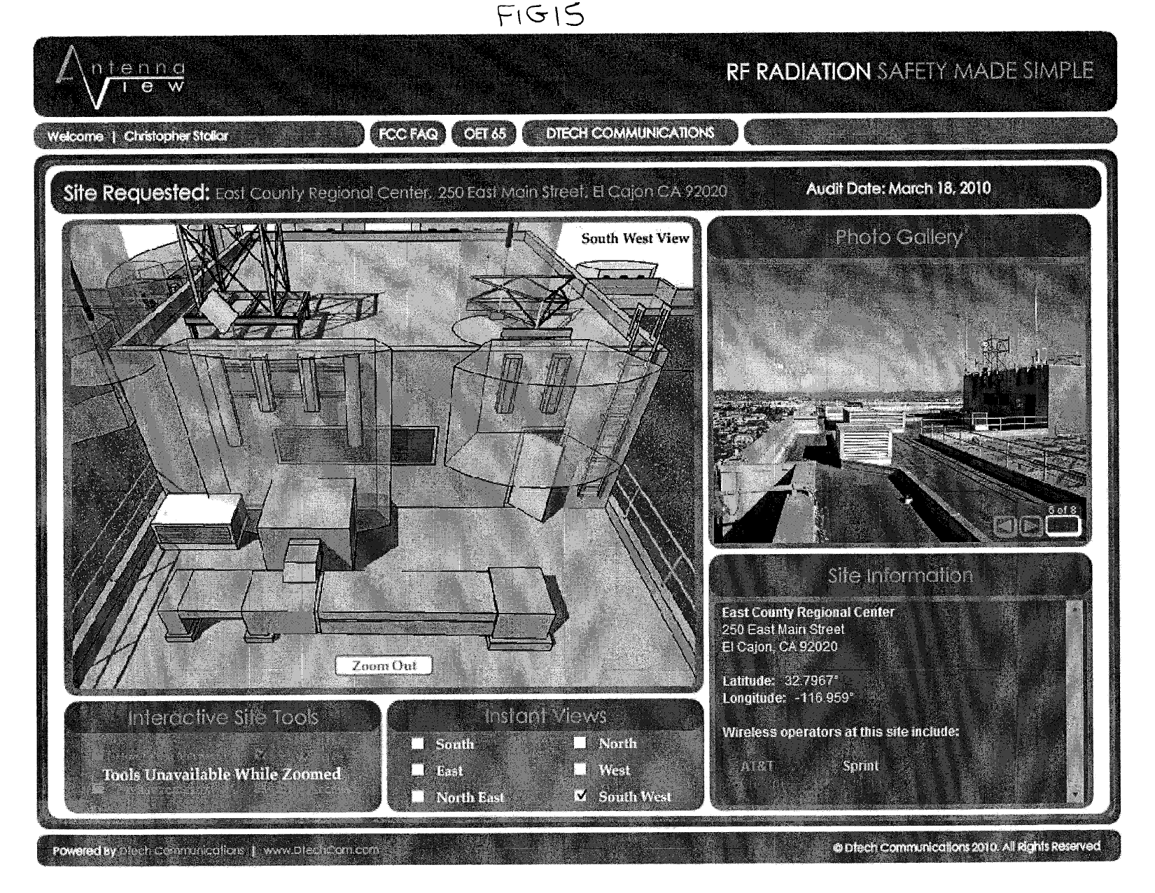

At step 340, a series of interactive tools are provided on-screen to the workers. At 341, an introductory tutorial is presented on how to use the interactive tools. At 342, the hot zones are displayed for the user. (These hot zones are seen in the screenshot of FIG. 13). At 344, the RF measurements are displayed for the user. For example, the displayed RF measurements may show actual values in percentages of the FCC's Maximum Permissible Exposure (MPE) and the locations where these measurements were conducted. (As seen in the screenshot of FIG. 14). As seen in the screenshot of FIG. 15, the user is able to view the building from different angles and zoom in and out.

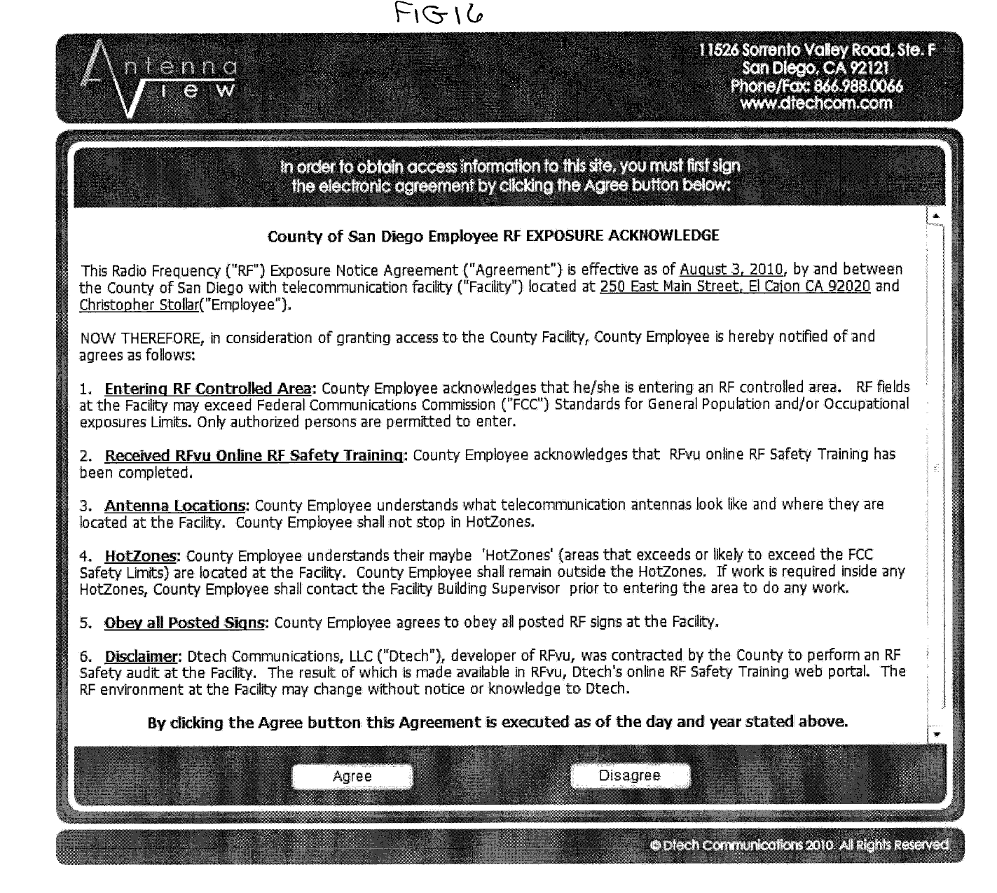

At 345, both the hot zones and measurement locations can be displayed for the user (and either can be turned on or off). At 346, the user is provided with a site-specific Agreement. As stated in the Agreement, the user must then acknowledge that they have reviewed the site-specific information. An exemplary Agreement is illustrated in the screenshot of FIG. 16. The worker is able to execute this Agreement by clicking on “Agree”. At this time, the worker is then certified to have completed their RF safety training for this particular building. The executed Agreements are then stored in database 50.

In optional aspects of the present invention, computerized system 10 is accessed through a mobile device application, and the steps of displaying and conducting on-line testing are performed on a mobile device.

What is claimed:

1. An on-line method of safety training and of certifying workers to work on a structure having at least one RF antenna, comprising:
(a) displaying non-site-specific information about RF antennae to the workers;
(b) conducting on-line testing of the workers on the non-site-specific information, by:
(i) presenting questions to the workers;
(ii) recording the workers' answers to the questions; and
(iii) determining whether the workers have passed the on-line non-site-specific testing; and if the workers have passed the on-line non-site-specific testing, then
(c) displaying site-specific information about the at least one RF antenna on the structure to the workers;
(d) certifying workers for work at a job site by having the workers acknowledge that they have seen the site-specific information; and then
(e) informing a facility manager that the workers have both have passed the on-line non-site-specific testing and have seen the site-specific information.

2. The method of claim 1, wherein displaying the non-site-specific information comprises:
displaying RF safety legal compliance information.

3. The method of claim 1, wherein displaying the site-specific information comprises:
displaying photographs of the at least one RF antenna on the structure.

4. The method of claim 1, wherein displaying the site-specific information comprises:
displaying 3D computer models of the structure and the at least one RF antenna.

5. The method of claim 1, wherein displaying the site-specific information comprises:
simultaneously displaying photographs and 3D computer models of the structure and the at least one RF antenna.

6. The method of claim 4, wherein displaying the site-specific information comprises:
displaying control zones or hot zones on the 3D computer models of the structure and the at least one RF antenna.

7. The method of claim 6, wherein the control zones and hot zones are calculated by taking RF measurements at the structure near the at least one RF antenna.

8. The method of claim 7, further comprising:
determining RF measurements at the structure with computer software,
merging the RF measurements taken at the structure with the RF measurements predicted with the computer software, and
displaying the merged RF measurements to the workers.

9. The method of claim 6, wherein the control zones and hot zones are represented by different colors.

10. The method of claim 1, wherein certifying workers for work at a job site by having the workers acknowledge that they have seen the site-specific information for the job site comprises:
(a) displaying a site-specific agreement to the workers;
(b) requesting that the workers execute the site-specific agreement; and
(c) receiving the executed site-specific agreements from the workers; and
(d) storing the executed site-specific agreements in a computer database.

11. The method of claim 1, wherein the steps of displaying and conducting on-line testing are performed on a mobile device.

12. The method of claim 1, further comprising:
sending a non-site specific certificate to the workers that have passed the on-line non-site-specific testing.

13. The method of claim 1, wherein the site-specific information comprises site-specific information for a plurality of different work sites, and wherein different workers view different site-specific information.

14. A software program embodied on a tangible, computer readable media comprising instructions for safety training and for certifying workers to work on a structure having at least one RF antenna, by:
(a) displaying non-site-specific information about RF antennae to the workers;
(b) conducting on-line testing of the workers on the non-site-specific and information, by:
(i) presenting questions to the workers;
(ii) recording the workers' answers to the questions; and
(iii) determining whether the workers have passed the on-line non-site-specific testing; and if the workers have passed the on-line non-site-specific testing, then
(c) displaying site-specific information about the at least one RF antenna on the structure to the workers;
(d) certifying workers for work at a job site by having the workers acknowledge that they have seen the site-specific information for the job site; and then
(e) informing a facility manager that the workers have both have passed the on-line non-site-specific testing and have seen the site-specific information.

15. A computerized system for safety training and certifying workers to work on a structure having at least one RF antenna, comprising:
(a) an access module permitting workers to access the computerized system;
(b) a non-site-specific training module that displays on-line information about RF antennae to the workers;
(c) a site-specific training module that displays on-line information about the at least one RF antenna on the structure to the workers;
(d) a certification module that conducts on-line testing of the workers on the non-site-specific information and certifies workers for work at a job site by having the workers acknowledge that they have seen the site-specific information for the job site; and
(d) a database module which stores:
(i) non-site-specific information called up by the non-site-specific training module during the on-line testing,
(ii) site-specific information called up by the site-specific training module during the on-line testing, and
(iii) records of which workers have both have passed the on-line non-site-specific testing and seen the site-specific information.

16. The computerized system of claim 15, wherein the non-site-specific information stored in the database is displayed to the workers by the non-site-specific training module.

17. The computerized system of claim 15, wherein the site-specific information stored in the database is displayed to the workers by the site-specific training module.

18. The computerized system of claim 15, wherein the access module receives both a worker's personal identifying information and site-specific identifying information prior to authorizing the worker to access the computerized system.

19. The computerized system of claim 15, wherein the site-specific training module displays site-specific information for a plurality of work sites, and wherein the access module permits different workers to access different site-specific information for different work sites.

20. The computerized system of claim 19, wherein the access module is controlled by a facility manager who determines which workers are permitted to access the computerized system, and which workers are permitted to access which site-specific information.

21. The computerized system of claim 15, wherein the site-specific training module tests different workers on different site-specific information for different work sites.

22. The computerized system of claim 15, wherein the site-specific training module displays photographs of the at least one RF antenna on the structure.

23. The computerized system of claim 15, wherein the site-specific training module displays 3D computer models of the structure and the at least one RF antenna.

24. The computerized system of claim 15, wherein the site-specific training module simultaneously displays photographs and 3D computer models of the structure and the at least one RF antenna.

25. The computerized system of claim 15, wherein the site-specific training module displays control zones and hot zones on the 3D computer models of the structure and the at least one RF antenna.

26. The computerized system of claim 15, wherein the site-specific training module displays RF measurements taken at the structure near the at least one RF antenna merged together with RF measurements determined by computer software.

27. The computerized system of claim 15, wherein the non-site-specific training module comprises:
(i) a system for asking questions;
(ii) a system for recording answers; and
(iii) a system for recording results.

28. The computerized system of claim 15, wherein the site-specific training module comprises:
(a) a system for displaying a site-specific agreement to the workers for execution by the workers;
(b) a system for receiving the executed site-specific agreements from the workers; and
(c) a system for storing the executed site-specific agreements in a computer database.

29. The computerized system of claim 15, wherein the database stores site-specific audit and compliance information.

30. The computerized system of claim 15, wherein the computerized system is accessed through a mobile device application.
